(19) United States
(12) Patent Application Publication
(10) Pub. No.: US 2010/0136355 A1
(43) Pub. Date: Jun. 3, 2010

(54) COATING COMPOSITION FOR PAPERS PROVIDING EXCELLENT WATER VAPOR BARRIER PROPERTIES

(76) Inventor: Jan Frans Van Den Abbeele Henk, Schaffen-Diest (BE)

Correspondence Address: WENDEROTH, LIND & PONACK, L.L.P., 1030 15th Street, N.W.,, Suite 400 East, Washington, DC, 20005-1503, US

(21) Appl. No.: 12/451,550

(22) PCT Filed: May 16, 2008
(86) PCT No.: PCT/EP2008/003945

§ 371 Date: Jan. 27, 2010

(30) Foreign Application Priority Data
May 18, 2007 (EP) 07009924.7

(51) Int. Cl. B32B 25/06; C09D 1/00; B05D 1/30; B05D 1/26; C08K 3/34

(52) U.S. Cl. 428/537.5; 106/287.1; 427/420; 524/451

(57) ABSTRACT

Composition for surface treatment of paper, paperboard or the like, which composition on a solids weight basis comprises: 20 to 55% of a binder with glass transition temperature lower than 30° C.; 45 to 80% of a talcum with an average particle size between 500 and 2000 nm, preferably 33 to 40% of a binder with glass transition temperature lower than 30° C.; 60 to 67% of a talcum with an average size between 500 and 2000 nm. The binder is a styrene butadiene latex, and the talcum has an aspect ratio of higher than 30, preferably of higher than 50, and the specific surface area of the talcum particles is between 10 and 20 m²/gr, preferably between 14 and 18 m²/gr.

The present invention relates to a composition for surface treatment of paper, paperboard or the like.

There is an ongoing trend to replace paperboard that is laminated with polyethylene films by paperboard that is coated with coatings that do not disturb the recycling process of the paperboard. Polyethylene films have very good water vapour barrier properties, however, the films will not disintegrate during the repulping process upon recycling of the paperboard. From an environmental point of view, there is a need to come up with new products. In an article described by Sridach et all, Paper and Timber Vol. 881 No2/2006, a barrier coating has been described based on biodegradable polyesters, so that the coated paperboard will be compostable. However, rather thick layers of the coating are needed to obtain sufficiently good water vapour barrier properties and hence this system is economically not attractive. Conventional types of barrier coatings applied to paper products include waxes. Although waxes confer excellent barrier properties, they can not be glued or over-printed very easily and are also problematic during the repulping process.

Accordingly, there is need for a water vapour barrier coated cellulosic substrate which is easy and inexpensive to manufacture, has good barrier properties with respect to water and water vapour, can be glued or over-printed easily, and can be easily disposed or recycled.

It is an object of the invention to provide such a coating.

This object is achieved in that the composition on a solid weight basis comprises: 20 to 55% of a binder with a glass transition temperature lower than 30° C.; 45 to 80% of a talcum with an average particle size between 50 and 2000 nm.

Accordingly to the present invention the composition that provides coatings with good water and water vapour barrier properties are obtained by choosing talcum particles with a specific particle size, combined with a specific weight ratio between the talcum particles and the binder.

For talcum in particular, the mean particle size is generally between 2 and 10 microns and is obtained by dry grinding and selection. However, it is found now that talcum with a smaller particle size has a dramatic effect on the water vapour barrier properties. To obtain these particles with smaller sizes one can use a ball mill delaminating process. The talcum to start with can have an average particle size of a few micrometers or can be more coarse. A way of making these fine talcum particles has been described in patent U.S. Pat. No. 6,348,536. The use of the products described in this patent for paper coatings is part of the present invention. This patent describes a wet grinding process leading to lamella-type minerals in the form of particles constituted of stacks of sheets. The process is characterized by the fact that the mineral is suspended in a liquid with a predetermined initial particle size, after which the suspension is subjected to a delamination procedure in order to separate the sheet from the particles, and obtain a particle size smaller than the initial particle size. Said suspension is then subjected to selection in order to eliminate the particles larger in size than the predetermined size; it is subsequently dried, and the mineral particles are treated so as to restrict the creation amongst them of strong irreversible bonds.

Good results can also be achieved by using a talcum with an average particle size smaller than 2000 nm obtained by a dry or wet milling process. A well-suited apparatus to obtain the requested particles is a Super-Orion Ball mill from Hosokawa Micron. The milling process should in first instance aim at increasing the aspect ratio of the particles. Most of the commercially available talcum products have an aspect ratio of less than 5. Due to ball milling process talcum particles with an average particle size below 2000 nm will start to delaminate, leading to a higher aspect ratio. Preferably the talcum particles have an aspect ratio of more than 30 and more preferably an aspect ratio of more than 50.

It should be noted that talcum with a particle size lower than 500 nm will be too expensive for obtaining water vapour barrier properties but also the hydrophobic properties are less good.

In a preferred embodiment of the invention the specific surface of the talcum is between 10 and 20 m²/gr, and more preferably between 14 and 18 m²/gr

In another preferred embodiment of the invention a talcum is used having a chlorite content between 8 and 30%, preferably between 10 and 20%, and more preferably between 10 and 16%.

A talcum that is very suitable for getting optimum water vapour barrier properties is a talcum from the Open mine of Trimouns (Pyrenees-France) that is treated according to the invention described in patent U.S. Pat. No. 6,348,536

The binder should be very hydrophobic, but should further allow gluing and over-printing of the resultant coating. A good comprise has been found by using styrene butadiene latex as a binder. Other good water borne binders are polyurethane, polyester or polyethyleneacrylate dispersions. The weight ratio between the binder and the talcum particles is chosen so that a maximum weight of talcum particles is obtained in the coating without creating pores in the coating. Dependent on the particle size of the talcum particles the weight ratio between the binder and the talcum particles will be between 20/80 and 55/45 and more preferably between 33/67 and 40/60.

The Tg of the binder should preferably be lower than 30° C. in order to provide good filming properties during the drying process. A Tg between 10° C. and 15° C. is most preferred.

For making the coating composition the talcum is dispersed in the water phase. To increase the stability of the dispersion classical dispersion aids can be added. Such a dispersion aid is for example Coatex P. The amount of dispersion aid will preferentially be not higher than 1%. Other additives may be added for instance to limit foaming behavior during the dispersion process.

After dispersing the talcum the water borne binder will be added.

In a preferred embodiment of the invention a weight amount of less than 5% of wax or oil can be added to increase the hydrophobic properties of the coating. Preferably, the amount of wax is less than 2%. Waxes that are suitable are for example parafine wax or fatty acids.

A small amount of a crosslinker such as for instance ammonium zirconium carbonate or formaldehyde resins can be added. Typical amounts of crosslinkers added are less than 3%. Higher amounts may hurt the recyclability of the paper

Low molecular weight organic solvents can be used in combination with water as the liquid carrier and examples thereof include alcohols such as methanol, ethanol, propanol, isopropanol and mixtures thereof. Especially when binders are used with a Tg higher than 30 C solvents are added to improve the film forming properties of the binder.

The coating may contain some other coating additives which are common for paper coating formulations. These can be for example colouring agents, optical brighteners or anti-microbial agents.

In a preferred embodiment of the invention the viscosity of the coating composition is between 10 and 800 centipoises, more preferably between 50 and 200. By doing so a good flow of the coating and an increased penetration of the composition can take place in the pores of the paper product.

The solids content of the formulation should preferably be between 45 and 65%, more preferably between 50 and 55%

In another preferred embodiment of the invention the compositions are applied on the paper or the paperboard by a coating machine having a bend blade, an air knife or a rod. Also curtain coaters are suitable for this application. Applications of the compositions by using machines having a stiff blade clearly showed inferior water vapor barrier properties. Application on paper. Rods to be used.

1. Composition for surface treatment of paper, paperboard or the like, characterized in that the composition on a solids weight basis comprises:
20 to 55% of a binder with glass transition temperature lower than 30° C.
45 to 80% of a talcum with an average particle size between 500 and 2000 nm.

2. Composition according to claim 1, characterized in that the composition on weight basis comprises:
33 to 40% of a binder with glass transition temperature lower than 30° C.
60 to 67% of a talcum with an average size between 500 and 2000 nm.

3. Composition according to claim 1 characterized in that the binder is a styrene butadiene latex.

4. Composition according to claim 1, characterized in that the talcum has an aspect ratio of higher than 30.

5. Composition according to claim 1, characterized in that the talcum has an aspect ratio of higher than 50.

6. Composition according to claim 1, characterized in that the specific surface area of the talcum particles is between 10 and 20 m²/gr, preferably between 14 and 18 m²/gr.

7. Composition according to claim 1, characterized in that the small particle size of the talcum is obtained by a wet milling process.

8. Composition according to claim 1, characterized in that the talcum has a chlorite content between 8 and 30%, preferably between 10 and 20%, more preferably between 10 and 16%.

9. Composition according to claim 1, characterized in that the solids content is 45 and 65%, more preferably between 50 and 55%.

10. Composition according to claim 1, characterized in that the viscosity of the formulation is between 10 and 800 centipoise, more preferable between 50 and 200 centipoise.

11. The application of compositions according to claim 1 for making water vapor barrier coatings on paper, paperboard and the like by using a coating machine with a bend-blade, air knife, curtain coater or a rod.

12. A cellulosic substrate coated with a composition according to claim 1.
